(19) United States
(12) Patent Application Publication
(10) Pub. No.: US 2010/0271533 A1
(43) Pub. Date: Oct. 28, 2010

(54) Image Recordation Device with a Plurality of Lenses

(75) Inventors: Alex Bogusky, Boulder, CO (US); Neil Riddell, Longmont, CO (US); Veronica Padilla, Denver, CO (US); Michael Kritzer, Boulder, CO (US)

Correspondence Address: KALOW & SPRINGUT LLP, 488 MADISON AVENUE, 19TH FLOOR, NEW YORK, NY, 10022, US

(73) Assignee: CRISPIN PORTER & BOGUSKY, Boulder, CO (US)

(21) Appl. No.: 12/755,444

(22) Filed: Apr. 7, 2010

Related U.S. Application Data
(60) Provisional application No. 61/173,245, filed on Apr. 28, 2009.

(51) Int. Cl. H04N 5/225

(52) U.S. Cl. 348/335; 348/E05.024

(57) ABSTRACT

Through the use of image recordation devices that have at least two lenses with non-overlapping fields of view, a photographer can better record a memorable event. Additionally, through the inclusion of a timing module, a user can record a plurality of candid images about these events at regular or irregular intervals.

### CROSS REFERENCE TO RELATED APPLICATION

This application claims the benefit of the filing date of U.S. Provisional Application Ser. No. 61/173,245, filed Apr. 28, 2009, the entire disclosure of which is incorporated by reference as if set forth fully herein.

### FIELD OF THE INVENTION

The present invention relates to the recordation of images.

### BACKGROUND OF THE INVENTION

Photography has been used for more than a century to record events, and both professional and amateur photographers have access to image recordation devices such as cameras that enable them to take photographs and to memorialize images for either real time or later viewing. In part, the widespread use of these devices has coincided with the advent of digital cameras. These cameras offer the benefits of the capacity to record and to store large numbers of images, and the ability to share these images with a large number of people.

Among the types of photographs that can be taken are those for which people pose because they know that they would like to preserve the memory of how they looked on a particular day. These events include, but are not limited to, weddings, birthdays, graduations, anniversaries, etc. Unfortunately, posed pictures only capture images when a subject knows that she is being photographed.

Moreover, they only record the image of one person or one set of people who are located in a particular spot at a particular time. Thus, they do not capture candid images or images in other locations.

One known way to address at least one of these issues is to assign or to hire a person to take photographs when the subject of the photograph does not know that a picture is being taken, and over time to have this person move to different spots. Unfortunately, this solution can be undesirably costly and unless multiple photographers are retained only one picture can be taken at a time.

For many people, a limited number of images and posed recordation of images are undesirable and lead to a less than satisfying experience when reviewing photographs. The present invention is directed to providing a more enjoyable experience to these people.

### SUMMARY OF THE INVENTION

The present invention is directed to devices for simultaneously recording a plurality of non-overlapping images, methods for using these devices and methods for viewing and sharing the images recorded by them.

According to one embodiment, the present invention provides an image recordation device comprising: a first lens, wherein said first lens is oriented in a first direction; a second lens, wherein said second lens is oriented in a second direction; and a central processing unit, wherein said central processing unit is capable of executing a set of instructions that causes the recordation of a first image of one or more objects within a field of view of the first lens and is capable of executing a set of instructions that causes the recordation of a second image of one or more objects within a field of view of the second lens, wherein the first lens and the second lens have non-overlapping fields of view and the device is capable of recording both the first image and the second image either simultaneously or within a period of less than one minute of each other.

According to another embodiment, the present invention is directed to a camera that comprises a housing unit that contains two camera lenses that are directed in opposite directions.

According to another embodiment, the present invention is directed to a method of sharing photographs. The method comprises taking a plurality of photographs from a plurality of lenses within a housing, wherein the lenses have non-overlapping fields of view; and providing the images to a computer (e.g., a remote computer) or to a recipient. The images may, for example, be uploaded onto a computer and/or printed for viewing. In some embodiments, at least two photographs are taken simultaneously (or within less than a minute of each other) to form a set of images and optionally presenting these images at the same time on a computer screen or on a photographic print for viewing by a person.

Through the various embodiments of the present invention, one may easily and efficiently, simultaneously record pictures in multiple views and obtain candid photographs in the process. Because the devices may be set unobtrusively and may be small, often they will be overlooked or forgotten by the subjects of the photographs. This will enable more natural photographs to be taken. Thus, in some embodiments, the present invention provides one or more of the following advantages: (1) one can monitor the changes in an environment even when one is not present (e.g. automating monitoring of people, objects, weather, etc.); (2) there can be a satisfaction of one's curiosity, enabling one to know what is happening when people forget or do not know that they are being watched; (3) there can be a cost savings, because one can use the device in many situations in which otherwise a photographer would be needed; and (4) one can capture spontaneity.

### BRIEF DESCRIPTION OF THE FIGURES

FIGS. 1A and 1B provide front views a device according to an embodiment of the present invention.

FIGS. 2A and 2B provide rear views a device according to an embodiment of the present invention.

FIGS. 3A and 3B provide top-down views a device according to an embodiment of the present invention.

### DETAILED DESCRIPTION OF THE INVENTION

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

### DEFINITIONS

Unless otherwise specified or apparent from context, the following terms and phrases have the meanings provided below:

The phrase “central processing unit” and the abbreviation “CPU” are used interchangeably and refer to an electronic circuit that can execute a computer program. The computer program may be embodied on tangible media. For example, a CPU may be an image-processing unit within a camera housing.

The phrase “image recordation device” refers to a device that may be used to record images. Thus, it may be used to record images on film or in digital format. An exemplary image recordation device is a camera. Unless otherwise specified an image recordation device may record individual images such as the images that form the basis of photographs, or may record series of images such as to create a movie. When the image recordation device is a camera, it may for example be a digital camera that records a plurality of individual images that can be displayed or printed as photographs. As persons of ordinary skill in the art are aware, a digital camera records images via an electronic image sensor, which is a device that converts an optical image to an electric signal. An individual image that forms the basis of a picture may be referred to as a still image regardless of whether the subject is moving at the time that the picture is being taken.

The term “lens” refers to an optical device that preferably has perfect or approximate axial symmetry and that transmits and refracts light by converging or diverging the beam. A simple lens is a lens that consists of a single optical element. By way of example, lenses may be made of glass or transparent plastic. For wide-angle or wide aspect ratio lenses, the focal length is commonly 35 mm or less.

The phrase “module” refers to a computer program product that may be stored on hardware and/or software that may be activated by a user to carry out a defined set of steps and/or to prompt a user to provide information through for example a graphic user interface and/or input/output device. Thus, a module may be stored in the form of a tangible medium.

The term “object” refers to any physical item that may be photographed including but not limited to animate and inanimate objects.

The phrase “real time” refers to the transmission of information as it is being recorded or substantially as it is being recorded. Thus, a transmission of an image in real time includes a transmission that occurs within the timeframe in which it takes for a camera to process an image, format it and send it to a destination, e.g. wirelessly over a network. This may include a small time period such as less than a few seconds or less than a fraction of a second.

The term “simultaneously” refers to the occurrence of two or more events at the same time or unless otherwise specified within less than a second of each other.

The phrase “operably coupled” refers to any connection that allows interoperability, including for example, being communicably coupled.

The abbreviation “URL” refers to a uniform resources locator.

The abbreviation “USB” and the phrase “universal serial bus” are used interchangeably and refer to a serial bus standard that is used to connect devices to a host computer. USBs allow many peripherals to be connected using a single standard interface socket. Through the use of USBs one is able to connect and to disconnect a device from a computer without needing to reboot the computer.

### PREFERRED EMBODIMENTS

According to one embodiment, the present invention provides an image recordation device comprising a first lens, a second lens and a central processing unit (e.g., image processing unit). The first lens is oriented in first direction and the second lens in oriented in a second direction.

The central processing unit is capable of executing a set of instructions that causes the recordation of a first image of one or more objects within a field of view of the first lens and is capable of executing a set of instructions that causes the recordation of a second image of one or more objects within a field of view of the second lens. In some embodiments, the first lens and the second lens have non-overlapping fields of view and the device is capable of recording both the first image and the second image either simultaneously or within a period of less than one minute of each other.

In some embodiments the first field of view and the second field of view are in opposite directions. Thus, they may capture images of items that are opposite each other, or on opposite sides of a room, table or other space. The device may also comprise a housing unit and the first lens and the second lens may be located on opposite sides of the housing unit.

When being located on opposite sides of a housing unit in some embodiments they may be located directly opposite each other. For example, they may be located the same distance from the top of the housing unit and be centered from the sides of the housing unit or located the same distance from the sides such that the centers of the lenses are situated along an axis (real or imaginary) that is perpendicular to a face of the housing. In other embodiments, the lenses are located on opposite sides of the housing, but not directly opposite each other. Thus, the first lens, which is located on the front of the housing unit, may be closer to a first side (e.g., left) of the housing unit and the second lens, which is located on the rear side of the housing unit may be located closer to a second side (e.g., right) of the housing unit. Because in some embodiments one goal is to make as compact a device as possible, and certain hardware is needed behind the lens in order to record images effectively, it may not always be desirable to have the lenses directly opposite each other.

Thus, as noted above one may consider two lens to be directly opposite each other when the centers of those lenses are located on opposite sides of the housing and the same distance from each of the edges of the housing such that the centers of the lenses are aligned. One may consider two lens to be substantially opposite each other when they are located on opposite sides of the housing and the centers of the lenses are out of alignment i.e., not directly opposite each other such that one lens is closer to one side (e.g., the right side) whereas the other lens is closer to the other side (e.g., the left side), but less than 1 cm, less than 9 mm, less than 8 mm, less than 7 mm, less than 6 mm, less than 5 mm, less than 4 mm, less than 3 mm, less than 2 mm, less than 1 mm or less than 0.5 mm out of alignment. As used herein, unless otherwise specified, lenses are considered to be opposite each other if they are either directly opposite each other or substantially opposite each other.

Additionally, the housing unit may be any regular or irregular shape, e.g. a cube, three-dimensional, rectangle, sphere, etc. In some embodiments, the housing unit is designed so that when in use each lens is capable of being situated perpendicular to the floor. The housing unit may for example, be made of plastic, metal, or other solid material that can adequately protect the functional elements, such as the hardware, of the device.

In some embodiments there are exactly two lenses. In some embodiments there are more than two lenses. The plurality of lenses may be situated at regular or irregular spacing from each other. For example, there may be three lenses oriented one hundred and twenty degrees apart. Or there may be three lenses and two of them are oriented one-hundred and eighty degrees apart, while the third lens is oriented ninety degrees away from each of the other two lenses.

In some embodiments, there may also be four lenses that are, for example, oriented with fields of view that are evenly spaced, e.g. ninety degrees from each other or one hundred and nine and one-half from each other when the fields of view include three-dimensional orientations.

In the simplest embodiment there are exactly two lenses, one oriented in one direction, e.g. out the front, and the out the rear. Thus, they are oriented in opposite directions.

The use of two lenses enables a user to record two images of different subject matters at the same time. This permits one to record an action/reaction relationship through the use of one device. For example, through one lens this device may record people yelling “surprise” at a surprise party and through the other lens, the device may record the image of the person being surprised. As another example, the device could be used at a baseball game where the device could be used to simultaneously record a batter getting a hit and a fan's reaction. In another example, the device could be used at a wedding to record the bride and groom while also recording the reactions of their guests.

In some embodiments, the first lens and the second lens have the same focal lengths and they may both be wide angle lenses. In other embodiments, the first lens has a first focal length and the second lens has a second focal length, wherein the first focal length is greater than or less than the second focal length. In some embodiments, both lenses may be associated with the same sensor such as a 3 megapixel sensor, or each may be associated with its own sensor. In some embodiments the focal length of the lens will be 35 mm or less. Common examples of focal lengths are 35, 28, 24, 21, 18 and 14 mm, and depending on the use, it may be advantageous to design the camera in which both (or all if there are more than two) lenses have focal lengths of 35 mm, 28 mm, 24 mm, 21, mm, 18 mm or 14 mm, or it may be advantageous to have the lenses have different focal lengths, e.g., 35 mm and 28 mm, 35 mm and 24 mm, 35 mm and 21 mm, 35 mm and 18 mm, 35 mm and 14 mm, 28 mm and 24 mm, 28 mm and 21 mm, 28 mm and 18 mm, 28 mm and 14 mm, 24 mm and 21 mm, 24 mm and 18 mm, 24 mm and 14 mm, and 21 mm and 18 mm, 21 mm and 14 mm, or 18 mm and 14 mm.

As noted above, the device is equipped with at least two lenses. However, in some embodiments, the user has the ability to select one lens, while not selecting the other. This feature provides more flexibility for the device, without wasting memory in applications for which recordation of images in only one direction is desired.

Optionally, the device may also have a camera focus adjust for each lens. The camera focus adjust may be responsible for providing a clear picture to the image sensor and in some embodiments is automatic. Each camera focus adjust, when present, is operably coupled to a lens.

Additionally, in some embodiments, it may be desirable to have separate charge-coupled devices for each lens. As with the camera focus, the charge-coupled devices are operably coupled to the central processing unit.

In some embodiments, the image recordation device comprises a flash for taking photographs when insufficient light is present. The flash may be operated automatically depending on the light that is present or it may be manually activated or the camera may have an option for the user to select whether the flash feature should be automatic or manual. Additionally, in some embodiments there is a lens protection element for each lens that can reversibly cover and uncover the respective lens. In other embodiments the device may include lenses having zoom capabilities. Still other embodiments may incorporate algorithms to improve the quality of the image by, for example, recognizing a face or scene as the intended subject matter.

The image recordation device may also comprise a memory unit or module.

In some embodiments the image is registered through the lens to an image sensor. The registered image is then stored into a memory module, e.g., a flash memory drive. In some embodiments, the memory module is capable of storing and recording the first image and the second image in digital format. In some embodiments, the memory module can hold at least 1 gigabyte. In some embodiments, the memory module can hold at least 2 gigabytes. In some embodiments, the memory module can hold at least 3 gigabytes. In some embodiments, the memory module can hold at least 4 gigabytes. In some embodiments, the memory module can hold at least 5 gigabytes. In some embodiments, the memory module can hold at least 10 gigabytes. The memory module is preferably non-volatile. Thus, when power is lost the contents of the memory are not lost.

The image recordation device may, in some embodiments, comprise a base that has one or more of the following elements: (1) legs on which to stand; (2) a suction cup for permitting attachment to a surface, including but not limited to a wall, a floor, a ceiling, a table, and a bookshelf; (3) either a hook or loop element to enable attachment to a reciprocal element on a different surface; (4) an element with a string, thread, chain or rope that permits the formation of a necklace or bracelet or a loop through which a string, thread, chain or rope may be inserted to form or to attach to a necklace or bracelet; (5) a clip; (6) a magnet; or (7) a combination thereof. In some embodiments, each of the aforementioned specific elements may be an alternate base that is attached to the housing unit of the device. Thus, in some embodiments, the device comprises a housing unit that is reversibly attached to a base, and the base may be interchanged with another base. In some embodiments, the present invention provides a kit that has the housing unit described above, and at least two bases that may reversibly be associated with the device, wherein each of these at least two bases has exactly one of the aforementioned elements or one or more of those elements. The mechanism for reversible attachment of the base with the housing unit may include, but is not limited to, a screw and screw thread, a locking pin, or a magnetic clasp.

Through the use of the different bases, the device may for example, hang from a rear view mirror in a car, sit on a bike handlebar, sit on a desk, hang from someone's neck or stick to a wall.

In some embodiments, the base is capable of reversibly associating said image recordation device with an element of a motor vehicle. The element may for example, be a rearview mirror. In some embodiments, the attachment mechanism comprises at least one arm, wherein said arm is flexible or semi-flexible so that it may be angled or adjusted to wraparound an item, but able to retain the form to which it has been adjusted.

The image recordation device may also comprise a timing module. The timing module may be capable of causing a first set of a plurality of images to be recorded from within the field of view of the first lens at preselected intervals and is capable of causing a second set of a plurality of images to be recorded from within the field of view of the second lens at preselected intervals. In some embodiments these time intervals are the same. Thus, in some embodiments, the device records a first set of images, X, wherein i varies from 1 to N and N is the number of images taken from the first lens, and the device also records a second set of images, Yⱼ wherein j varies from 1 to M and M is the number of images taken through the second lens. In some embodiments, the device uses both lenses to take one or more pairs of photographs at the same time (within a pair of photographs, one picture having been taken from each lens). In such embodiments, the data that corresponds to each pair of images is (Xᵢ, Yⱼ) where i=j. If one of the lenses is deactivated, e.g. the second lens, and only an image X, is recorded, the corresponding data Yⱼ would be empty or otherwise contain information that indicates that no image was recorded.

When the images are later uploaded to a computer terminal for display and/or printouts, an algorithm will be able to associate images for which i=j, and either as a default or after receiving an appropriate input instruction display the corresponding (Xᵢ, Yⱼ).

The aforementioned time intervals may for example be regular intervals of every five seconds, every ten seconds, every fifteen seconds, every thirty seconds, every forty-five seconds, every minute, every two minutes, every three minutes, every four minutes, every five minutes, every six minutes, every seven minutes, every eight minutes, every nine minutes, every ten minutes, every eleven minutes, every twelve minutes, every thirteen minutes, every fourteen minutes, every fifteen minutes, every half of an hour, every hour, every two hours, every three hours, every four hours, every five hours, every six hours, every twelve hours, every twenty-four hours, every week, etc.

The timer may also be designed to contain a computer program product that when accessed by the central processing unit permits a user to select a regular or random function that will cause photographs to be taken at random time periods within a range, for example to take an additional set of pictures at regular or irregular intervals such as every one second to one minute, every one to five minutes, every five to ten minutes, every ten to twenty minutes, every twenty to thirty minutes, every thirty minutes to an hour, every one to two hours or any combination of the aforementioned ranges. The timing module may be operably coupled with a sensor module and/or with the memory module.

Additionally, the device may contain a stagger module such that the image recorded from the second lens is always or on command recorded a predetermined number of seconds before or after the first image is recorded, e.g. 0.1 to 0.5 seconds, 0.5 to 1.0 seconds, 1.0 to 2.0 seconds, 2 seconds to 4 seconds, 4 seconds to ten seconds, ten seconds to thirty seconds or thirty seconds to one minute.

The image recordation device may also comprise a global position satellite recordation module that is capable of detecting the geographic position of the device, causing storage of a geographic position of said image recordation device at the time of image recordation, and associating that information with the corresponding images. In some embodiments, when the user accesses the image, for example, via the Internet, the user may view the image of a map illustrating the location where the photo is taken. This module is preferably operably coupled with the memory module and/or the sensor module.

Further, the device may comprise a time stamping module that records the time at which each image is taken. The time stamping module may record information in reference to the date, and time in hours, minutes, etc. or in reference to the amount of time since a previous picture was taken. This module is preferably operably coupled to the CPU and to the memory module.

The image recordation device may also comprise a transmission module, wherein said transmission module is capable of transmitting at least one of said first image and said second image to a computer. The transmitting may for example be through a wireless network. This transmission may be in real time, on command or on a time delay. In some embodiments, the device comprises a universal serial bus port for connecting to a computer.

According to another embodiment, the present invention provides a motor vehicle such as an automobile, plane or boat comprising: (a) an interior cabin; and (b) one of the aforementioned image recordation devices. The first lens may be oriented to record an image of a view external to said cabin and the second lens is oriented to record an image of an interior view of the cabin. In some embodiments, the image recordation device is affixed to a rearview mirror or the dashboard or to the windshield. This device may be used when the motor vehicle is stationary and/or in motion. In the motor vehicle the focal lengths of lenses may be different.

According to another embodiment, the present invention provides a method for creating a trip log, wherein the trip log comprises a plurality of sets of images, wherein each set of images comprises at least two images that are recorded at the same time or within a period of less than one minute of each other and wherein each set of images of said plurality of sets of images are recorded at different times, wherein said images are recorded by one of the aforementioned image recordation devices.

Certain embodiments of the present invention may be further illustrated by reference to the figures. Through the figures, the same numbers are used to refer to the same elements.

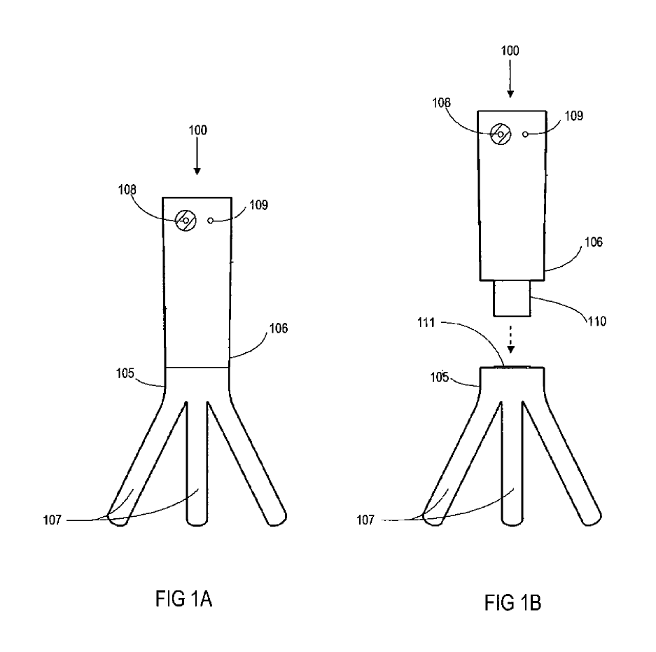

FIG. 1A shows a front view of the device 100. A first lens 108, which may be behind a glass covering is present, as is a first light emitting diode (LED) identification light 109, which has the same function as a second LED, described below (not shown in FIG. 1). The first LED light may have the ability to communicate to a subject of the photograph that a picture is about to be taken. For example, the light may change color from e.g. red to green or remain the same color but appear as a flashing light that increase in frequency when a picture is about to be taken.

Also shown are the housing unit 106, the base 105 and tripod legs 107. Although in these figures a base with three legs is shown, a person of ordinary skill would appreciate that more than three legs may be present.

FIG. 1B shows the device 100 in which the camera housing unit 106, with the first lens 108 and the first LED identification light 109 are separated from base 105, with the tripod legs 107.

With the two elements separated, a USB prong 110 is revealed as being connected to the housing, and a USB clip 111 is shown, for attachment of the base to the housing. The USB prong can be designed to be reversibly exposed and contained within the housing unit so that by attaching the base to the housing unit, the USB prong is physically pushed with the housing unit. Alternatively, the base can be designed to be of an appropriate configuration such that the USB prong sits within the base when the base and the housing unit are engaged.

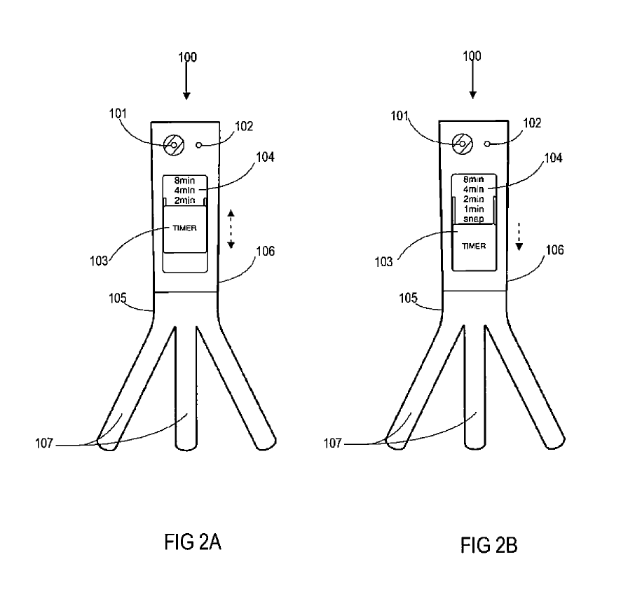

FIGS. 2A and 2B show the rear view of an embodiment of the present invention in two different time selected positions.

In these figures, the device or camera unit 100 has a second lens 101 through which the device can view and image. The lens is situated within the housing or camera unit body 106, and may be situated under a covering, e.g. a glass covering to protect the lens. A second light emitting diode light (LED) 102 is situated proximal to the second lens and serves as second LED identification light.

The device may also contain a time selection feature. In the device that appears in the figures, this feature is activated through a time slide 103, which can be moved vertically to select a particular interval at which a plurality of photographs should be taken. In FIG. 2A, an interval of 2 minutes is selected. In FIG. 2B the indicated selection is “snap,” which refers to a single snapshot to be taken when the device is activated. In some embodiments, the device is activated when the lens has been turned on through, for example, a power switch and a timed setting is selected. The device may be shut-off, for example, manually, automatically upon the expiration of a designated timed period, or when the storage has reached full capacity.

Also shown is the removable tripod base with deposable legs 107. The base may be manually rotated to ensure the most stable orientation. Additionally, each leg is sufficiently flexible to be bent in order to wrap around a fixture and is sufficiently sturdy to hold any position to which it is molded. In some embodiments the legs of the base may be adjusted to vary the position of the lenses.

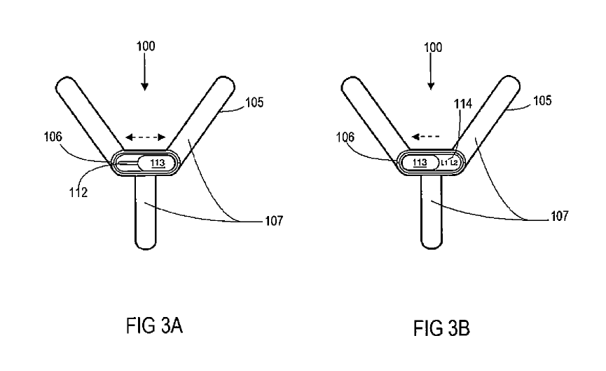

FIGS. 3A and 3B show the base 105 of the device 100, including the legs 107, as well as the housing of the camera device unit 106 from a view from the top. In order to activate the device, there is a power slider base 112, a power slider 113 and power/lens settings that permit the selection of L1, (which corresponds to the first lens and which may be positioned in a forward direction) or L2, which corresponds to selection of both L1 and L2 (L2 referring to the second lens which may be oriented in the rear or aft direction).

The devices and methods of the present invention may have many diverse applications. For example, the devices may be placed on a table at an event such as at a wedding, prom or other event. In such applications, it may be advantageous to position a device such that the lenses are not obstructed by centerpieces, candelabras, glasses or other items. One means to ensure an unobstructed field of vision is to place the device atop of a centerpiece or within space in the centerpiece or candelabra that is designed for placement of said device, e.g. a centerpiece or candelabra with a platform that is unobstructed by any other elements of said centerpiece or candelabras. In some embodiments, the centerpiece or candelabra will have two, three, four or more such platforms.

Additionally, when the device is to be placed on a table or on an item that is on a table, it is important to remember that people usually sit in the same chair throughout an event, and thus, one runs the risk of receiving multiple pictures of only the same people. If this is not desired, one may, as suggested above, use multiple cameras or either place the device on something that can be rotated either manually (e.g. a lazy susan) or automatically, or to equip the device with an additional mechanism rotation feature that can be activated as desired.

A rotation feature would be a mechanism that causes the housing element to rotate a selected number of degrees at a selected time. Some embodiments will employ a timing device to track the time and to signal the rotation of the base rotation mechanism. For example, it may rotate 30 degrees every two minutes, or it may rotate 45 degrees every two minutes, or it may rotate 90 degrees every two minutes. Thus, the rotation feature may have selections that are independent of the timing features.

A person may independently select for the device to rotate about 5 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees or 90 degrees about every 30 seconds, every 1 minute, every 2 minutes, every 3 minutes, every 4 minutes, every 5 minutes, every 6 minutes, every 7 minutes, every 8 minutes, every 9 minutes, every 10 minutes, every 15 minutes, every 20 minutes, every 30 minutes, every 40 minutes, every 50 minutes, or every 60 minutes, etc.

Thus in some embodiments the housing element rotates 10-30 degrees every one to five minutes or 30-50 degrees every one to five minutes or 50-70 degrees every one to five minutes or 70-90 degrees every one to five minutes. In some embodiments, for example, the device may snap pictures continuously as the base rotates or the base may rotate to a position and stop allowing the device to capture an image before continuing its rotation.

The devices of the present invention may also be particularly useful in sociology, psychology and photojournalist applications. For example, one or more devices may be strategically or randomly placed at large sporting events, such as concerts, or in heavily traveled places such as train stations or airports. When the devices are used to record events over larger periods of time, in some embodiments, it may be advantageous to include voice sensors and/or motion sensors that permit the device to move from a sleep mode to an active mode. For example, if the device detects no motion for at least one hour during which it has been taking pictures, it may cease to take additional pictures, and enter a sleep mode in which it monitors the area for motion and/or sound and after a sufficient level of motion and/or sound are detected, it may resume taking pictures.

In addition to providing novel and unobvious devices and methods for taking pictures, the present invention produces novel and unobvious systems and methods for sharing of pictures.

In some embodiments, the devices of the present invention are USB compliant. Thus, they can easily connect with a computer to recharge the power supply and to upload content. Once the device is attached to a computer, an auto-run script will tell the host computer to launch a web browser and to go to a specified domain e.g. at a URL site. At this domain, the user will be able to upload the imagery.

The computer program product that facilitates this upload will retain any GPS and/or time data associated with the photographs. It will also provide users with the option of viewing sets, e.g., pairs of pictures that were recorded simultaneously or within one minute of each other. For example, they may appear side-by-side or vertical, relative to each other. In other embodiments, the user may first view the image from one lens then view the image from the second lens. In these embodiments, when viewing the image from the second lens, the image from the first lens may in some embodiments disappear, be made smaller so that it is smaller than the image from the second lens, or be of the same size as the image from the second lens.

In embodiments that contain GPS tracking, a user may be able to display the pictures in a manner that demonstrates progression on a map. Similarly, in embodiments that are time stamped, the user may be able to display the images in a manner that demonstrates progression through time, e.g. with a clock display.

The software may also contain a review duplicator feature. In this feature, the software, capable of comparing data points in an image, may cause the display to skip over photographs that are too similar to other photographs. For example, the software may be stored on a server and may be accessible through the Internet. Additionally, the software may contain a photograph filter function that enables a viewer to see photographs taken at longer time intervals than the intervals at which the entire universe of photographs were recorded. For example, if the photographs were recorded every minute for four hours, there would be 240 photographs. A viewer may not have time to view all 240 photographs. Accordingly, through activation of a photograph filter module, a viewer may select time intervals of every 5 minutes to every 10 minutes, thereby reducing the number to view the forty-eight or twenty-four respectively.

Viewing of the images can be configured to form an automatic slide show, e.g. a new image appears at regular intervals or irregular intervals between every 10-15 seconds, every 15-20 seconds, every 20-25 seconds, every 25-30 seconds or every 30-35 seconds, etc. Alternatively, a view may be able to control the projection by hitting <<enter>> or another key designed to receive this information.

In exemplary embodiments, the device contains two 3 megapixel image sensors, a USB 2.0 compliant drive for uploading and charging the power supply (e.g., rechargeable battery), direct connect software for connectivity once the device is attached to a computer, a power supply such as a rechargeable battery, a 2 gigabyte flash storage for image storage, two LED indicator lights to signal that the device is in use and which lens is activated, alternate base options (e.g. tripod legs, clip, necklace, etc.) and two timer slide settings, a top slider to turn the device off or turn on the lens or to turn on the first or second lens, and a side slide to set the interval for picture taking, such as 8 minutes, 4 minutes, 2 minutes, 1 minute and instant viewer shots.

In some embodiments the power supply is a rechargeable battery. The battery may supply enough power to operate the functions of the device including the lenses for capturing one or more images, as well as the storage device to store the captured images and the timing device indicating when to capture an image. In an exemplary device, the battery may provide between 3.4 and 4.2V of power to operate the device. In some embodiments, the device may require 3.7V of power.

In some embodiments, the device is small and unobtrusive. For example, the housing unit may be between 15 and 40 mm wide or between 20 and 35 mm wide (corresponding to the width of the face on which the lenses are situated); between 50 and 100 mm or between 60 and 80 mm long (corresponding to the other dimension of the faces on which the lenses are situated); and between about 3 and 15 mm deep or between 7 and 13 mm deep (corresponding to the dimensions between the two faces on which the lenses are situated).

When the base is formed from at plurality of legs, e.g., three, four, five, six or more, in some embodiments, the distance between the bottom of the housing unit and the distal tip of the legs may be between 50 and 100 mm or between 65 and 85 mm. For stability, the legs may in some embodiments, when opened form points on a circle of a diameter of between 6 and 20 mm or between 10 and 15 mm.

This patent application discusses specific embodiments of the present invention. The specific features described herein may be used in some embodiments, but not in others, without departing from the spirit and scope of the invention as set forth in the foregoing disclosure.

We claim:

1. An image recordation device comprising:
a first lens, wherein said first lens is oriented in a first direction;
a second lens, wherein said second lens is oriented in a second direction; and
a central processing unit, wherein said central processing unit is capable of executing a set of instructions that causes the recordation of a first image of one or more objects within a field of view of the first lens and is capable of executing a set of instructions that causes the recordation of a second image of one or more objects within a field of view of the second lens, wherein the first lens and the second lens have non-overlapping fields of view and the device is capable of recording both the first image and the second image either simultaneously or within a period of less than one minute of each other.

2. The image recordation device of claim 1, wherein the first field of view and the second field of view are in opposite directions.

3. The image recordation device of claim 1, wherein the first lens and the second lens are located on opposite sides of a housing unit.

4. The image recordation device of claim 1 further comprising a memory unit.

5. The image recordation device of claim 4, wherein the recordation of the first image and the recordation of the second image are in digital format on said memory unit.

6. The image recordation device of claim 1 further comprising an attachment mechanism, wherein said attachment mechanism is capable of reversibly associating said image recordation device with an element of a motor vehicle.

7. The image recordation device of claim 6, wherein said element is a rearview mirror.

8. The image recordation device of claim 6, wherein the attachment mechanism comprises at least one arm, wherein said arm is flexible.

9. The image recordation device of claim 1 further comprising a timing module, wherein said timing module is capable of causing a first set of a plurality of images to be recorded from within the field of view of the first lens at preselected intervals and is capable of causing a second set of a plurality of images to be recorded from within the field of view of the second lens at preselected intervals.

10. The image recordation device of claim 1 further comprising a global position satellite recordation module that is capable of associating and causing storage of a geographic position of said image recordation device at the time of recordation.

11. The image recordation device of claim 1 further comprising a transmission module, wherein said transmission module is capable of transmitting at least one of said first image and said second image to a remote computer.

12. The image recordation device of claim 11, wherein said transmission is in real time.

13. A motor vehicle comprising:
an interior cabin; and
the image recordation device of claim 1, wherein said first lens is oriented to record an image of a view external to said cabin and the second lens is oriented to record an image of an interior view of the cabin.

14. The motor vehicle of claim 13, wherein said image recordation device is affixed to a rearview mirror.

15. The motor vehicle of claim 14, wherein said motor vehicle is an automobile.

16. A method for creating a trip log, wherein the trip log comprises a plurality of sets of images, wherein each set of images comprises at least two images that are recorded at the same time or within a period of less than one minute of each other and wherein each set of images on said plurality of sets of images are recorded at different times, wherein said images are recorded by the image recordation device of claim 1.

17. The method according to claim 16, wherein said image recordation device is located within the cabin of a motor vehicle.

18. The method according to claim 17, wherein the motor vehicle is moving.

19. A camera comprising:
a housing unit;
two camera lenses, wherein said two are located on opposite sides of said housing unit; and
a central processing unit, wherein said central processing unit is capable of simultaneously recording an image in each lens' field of view.

20. The camera of claim 19 further comprising a universal serial bus port.
